(19) United States
(12) Patent Application Publication
(10) Pub. No.: US 2015/0358700 A1
(43) Pub. Date: Dec. 10, 2015

(54) APPARATUS AND METHOD FOR ENABLING A PASSIVE OPTICAL NETWORK ON SUPPORTING TIME SYNCHRONIZATION

(71) Applicant: INDUSTRIAL TECHNOLOGY RESEARCH INSTITUTE, Hsinchu (TW)

(72) Inventors: Shi-Wei LEE, Chiayi County (TW); Chih-Hung HSU, Taichung City (TW); Jui-Ting WU, Hsinchu County (TW); Xun-Da CHEN, Keelung City (TW)

(73) Assignee: INDUSTRIAL TECHNOLOGY RESEARCH INSTITUTE, Hsinchu (TW)

(21) Appl. No.: 14/831,367

(22) Filed: Aug. 20, 2015

Related U.S. Application Data
(62) Division of application No. 13/870,593, filed on Apr. 25, 2013.

(30) Foreign Application Priority Data
Dec. 17, 2012 (TW) 101147891

(51) Int. Cl. H04Q 11/00; H04J 14/08; H04J 3/06

(52) U.S. Cl. CPC H04Q 11/0067; H04J 3/0673; H04J 3/0667; H04Q 11/0066; H04J 14/08; H04Q 11/0005; H04Q 2011/0045

(57) ABSTRACT

An apparatus for enabling a passive optical network (PON) having an OLT and at least one ONU on supporting time synchronization is disclosed. The apparatus comprises a timestamp correction module configured to make at least one network delay between the OLT and the at least one ONU of the PON equivalent to an equivalent path delay, wherein the timestamp correction module, through the PON, makes the at least one ONU responsible for modifying the timestamp in at least one PTP packet from the OLT, so that a slave clock at the backend of the at least one ONU is equivalent to synchronizing with a virtual master clock. The disclosure computes and corrects PTP commands so that the PTP clock at an ONU's backend may synchronize precisely with the master clock at an OLT's front end.

### CROSS-REFERENCE TO RELATED APPLICATION

The present application is a Divisional application of co-pending U.S. application Ser. No. 13/870,593, filed on Apr. 25, 2013, which claims priority from the Taiwan Application No. 101147891, filed on Dec. 17, 2012, which is herein incorporated by reference.

### TECHNICAL FIELD

The present disclosure generally relates to an apparatus and method for enabling a passive optical network (PON) on supporting time synchronization.

### BACKGROUND

With the development and deployment of PON network technology, the network technology has been developed to transmit synchronous information to make the backend optical network unit (ONU; ONU also known as the client) precisely synchronizing with the high-level clock source of the optical line termination (OLT). For example, the IEEE 1588 precision time protocol (PTP) developed by the Institute of Electrical and Electronic Engineers (IEEE) is used to provide the slave clock for synchronization with the master clock through the wired network. The PTP transmits synchronous timing signals through IP network or Ethernet, to achieve time precision of sub-microsecond level, which is regarded as an economic and effective way of clock distribution and system synchronization.

The IEEE 1588 synchronization mechanism provides precision synchronization of the slave clock with the master clock. FIG. 1 shows a schematic view for the IEEE 1588 synchronization mechanism. In the synchronization mechanism of FIG. 1, the target of the slave clock synchronizing with the master clock is calculating the propagation delay between the master clock and its slave clock to correct the slave clock to achieve the time synchronization. In the synchronization mechanism, the PTP master clock and its PTP slave clock use four messages for exchange, and these four messages include a sync message 110, a follow-up message 120, a delay request message 130, and a delay response message 140. In FIG. 1, the offset is the time difference between the master clock and its slave clock, the delay is the message propagation delay time between the master clock end and the slave clock end.

Refer to FIG. 1, the PTP master clock end periodically transmits the synchronization message 110 to the PTP slave clock end. The synchronization message 110 comprises a timestamp of the transmitting end. The timestamp records a time point MT1 of the master clock at the transmission instant, and therefore the receiving end may obtain the time point MT1 at the transmission instant. The master clock end may also transmit the follow-up message 120 after the synchronization message 110 is transmitted. The follow-up message 120 records the time point MT1. This implementation method is called two-phase synchronization. In the PTP protocol, the later phase of the aforementioned two-phase synchronization may use software for implementation, and this implementation may more precisely record the time point MT1. When a device equipped with hardware for supporting capability of direct recording time at the lower layer, the follow-up message 120 need not be used.

When the slave clock receives the synchronization message 110, the mechanism records a time point ST1 of the slave clock, and transmits the delay request message 130 to the master clock end. The delay request message 130 comprises a time point ST2 of the slave clock when transmitted. When the master clock end receives the delay request message 130, the mechanism records a time point MT2 of the main clock at that time, and transmits back the delay response message 140 to the slave clock end, thereby the slave clock end may obtain the time point MT2. According to the message exchanged up to now, there are four timestamps at the slave clock end, i.e. the time point MT1, the time point ST1, the time point MT2, and the time point ST2.

Therefore, the time difference amount between the master clock and its slave clock, and the propagation delay time between the master clock end and the slave clock end may be calculated as follows:

Since ST1=MT1+Offset+Delay, and MT2=ST2−Offset+Delay, so Delay=((ST1−MT1)+(MT2−ST2))/2, and Offset=((ST1−MT1)−(MT2−ST2))/2.

Accordingly, the use of the time difference amount Offset between the master clock and its slave clock may thereby adjust the time of the slave clock in synchronization with the time of the master clock. In the IEEE 1588, the synchronization scheme is called delay request response mechanism.

FIG. 2 shows a schematic view of a time synchronization application of a PON network. The application is that a slave clock device 220 of an ONU backend synchronizing with a PTP master clock 210. However, due to the variable queuing delay generated by the PON network, directly performing PTP packet delivery through the PON may fail to achieve the precise synchronization. Therefore, both the OLT and the ONU of the PON network must support the synchronization to accomplish the application.

In the synchronization of an OLT with an ONU in the existing PON networks, in addition to the propagation delay between the OLT and the ONU may be learned through the ranging, the ONU is responsible for locking the clock from the OLT, so that each ONU may avoid collision in accordance with the time slot for upstream bandwidth allocation arranged by the OLT. In the specification of the PON, the OLT also transmits the time of day clock (ToD) of the OLT to the ONU. Since the ONU locks the OLT clock, so the time of day clocks of both the OLT and the ONU exit only a small difference, which generally are considered to be the same value.

Usually the PTP synchronization needs both ends exchanging multiple messages to determine the error between the slave clock and the master clock. In existing PON networks, a synchronization method is that the OLT and the ONU are clock sources, respectively. The OLT is the master clock and the ONU is the slave clock when the OLT synchronizes with the ONU via the PTP. There is a technique, wherein the synchronization of the OLT and the ONU may learn the propagation delay between the OLT and the ONU through ranging, so when the OLT synchronizes with the ONU, it does not need transmitting multiple protocol messages back and forth as the PTP synchronization, simply bears the information in a fixed location of a GPON (Gigabit-capable PON) Transmission Convergence (GTC) frame, and then adds the known propagation delay to obtain the needed setting timing when the ONU receives the GTC frame. Another technique re-defines a timestamp reference point for synchronization of the OLT and the ONU of the PON network. Since the reference timestamp point used by IEEE 1588 is not encapsulated into the PON frame when on Ethernet over PON, therefore the technology re-defines the PON timestamp reference point for the OLT synchronizing with the ONU.

In another synchronization method of existing PON networks, the OLT and the ONU do not maintain the PTP clock respectively. The PON network is only responsible for transmitting synchronization package. i.e., the OLT master clock directly synchronizes with the ONU slave clock. Since when the PTP is executed, the delay time of two directions between the master clock end and a slave clock end must be equal, otherwise error will be induced. Some technologies provide solutions. For example, a technology tries to generate an equal delay for all PTP commands passing on the PON, so that the master clock directly synchronizing with the slave clock may use the standard synchronization calculation method to obtain a precision time. FIG. 3A shows a flow chart of a delay controlling scheme in the PON network. The controlling delay scheme stores uplink and downlink packets into a buffer to generate additional delay time. When the generated uplink and downlink PTP packets pass the PON, it will always be delayed to a fixed buffer duration, such as 600 μsec (this value is the logically longest delay time from the ONU to the OLT of the PON) to meet the delay requirements of the symmetrical transmission, that is, the buffering fix delay in FIG. 3B, so that the transmission delay Td3 from the ONU to the OLT equals to the transmission delay Td2 from the OLT to the ONU. In the delay controlling technology of FIG. 3A and FIG. 3B, the transmission delay Td3 of different ONUs may be influenced by the uplink bandwidth to lead to an error.

Understanding these synchronization mechanisms, synchronization technologies, and delay controlling technologies for existing PON networks, it will be an important issue on how to design a technology that only uses the synchronization information of the OLT informing the ONU to enable the PON network on supporting time synchronization capability and then make the slave clock connected to the ONU backend able to synchronize with the OLT upstream master clock.

### SUMMARY

The exemplary embodiments of the disclosure may provide an apparatus and method for enabling a passive optical network (PON) on supporting time synchronization.

One exemplary embodiment relates to an apparatus for enabling a passive optical network (PON) on supporting time synchronization. The PON has an optical line terminal (OLT) and at least one optical network unit (ONU). The apparatus may comprise a boundary clock device deployment unit configured to make the PON equivalent to a boundary clock device; wherein the OLT maintains a first precision time protocol (PTP) boundary clock, and the at least one ONU maintains a second PTP boundary clock, and in between the OLT and a master clock at a front end of the OLT, and in between a slave clock at a backend of the at least one ONU and the at least one ONU, a respective PTP is used to maintain synchronization.

Another exemplary embodiment relates to an apparatus for enabling a passive optical network (PON) on supporting time synchronization. The PON has an optical line terminal (OLT) and at least one optical network unit (ONU). The apparatus may comprise a timestamp correction module configured to make at least one network delay between a master clock and a slave clock equivalent to an equivalent path delay; wherein the timestamp correction module makes the at least one ONU responsible for modifying a timestamp information in at least one precision time protocol (PTP) packet from the OLT through the PON, so that the slave clock at a backend of the at least one ONU is equivalent to synchronizing with a virtual master clock.

Yet another exemplary embodiment relates to a method for enabling a passive optical network (PON) on supporting time synchronization. The PON has an optical line terminal (OLT) and at least one optical network unit (ONU). The method may comprise: deploying the PON equivalent to a boundary clock device; maintaining a first precision time protocol (PTP) boundary clock in the OLT, and maintaining a second PTP boundary clock in the at least one ONU; and in between the OLT and a master clock at a frontend of the OLT and in between a slave clock at a backend of the at least one ONU and the at least one ONU, using a respective PTP to maintain synchronization.

Yet another exemplary embodiment relates to a method for enabling a passive optical network (PON) on supporting time synchronization. The PON has an optical line terminal (OLT) and at least one optical network unit (ONU). The method may comprise: making at least one network delay between a master clock and a slave clock equivalent to at least one equivalent path delay; configuring a timestamp correction module in the PON, wherein the timestamp correction module modifies a timestamp information in at least one PTP packet from the master clock at a frontend of the OLT through the PON; and synchronizing, based on a modified timestamp information, the slave clock at a backend of the at least one ONU with a virtual master clock.

### BRIEF DESCRIPTION OF THE DRAWINGS

FIG. 1 shows a schematic view for the IEEE 1588 synchronization mechanism.

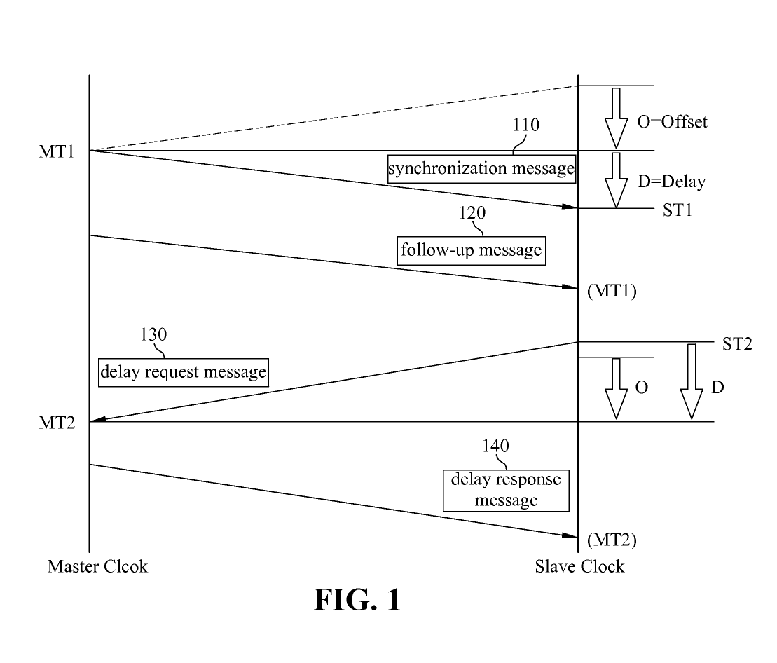

FIG. 2 shows a schematic view of a time synchronization application of a PON network.

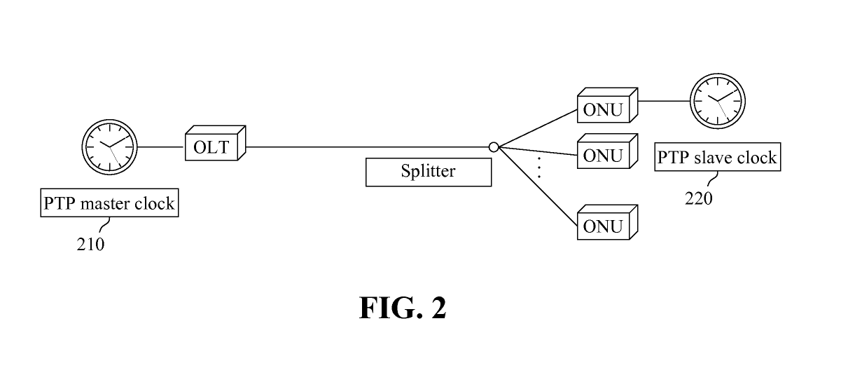

FIG. 3A and FIG. 3B shows schematic views illustrating a delay controlling scheme in the PON network.

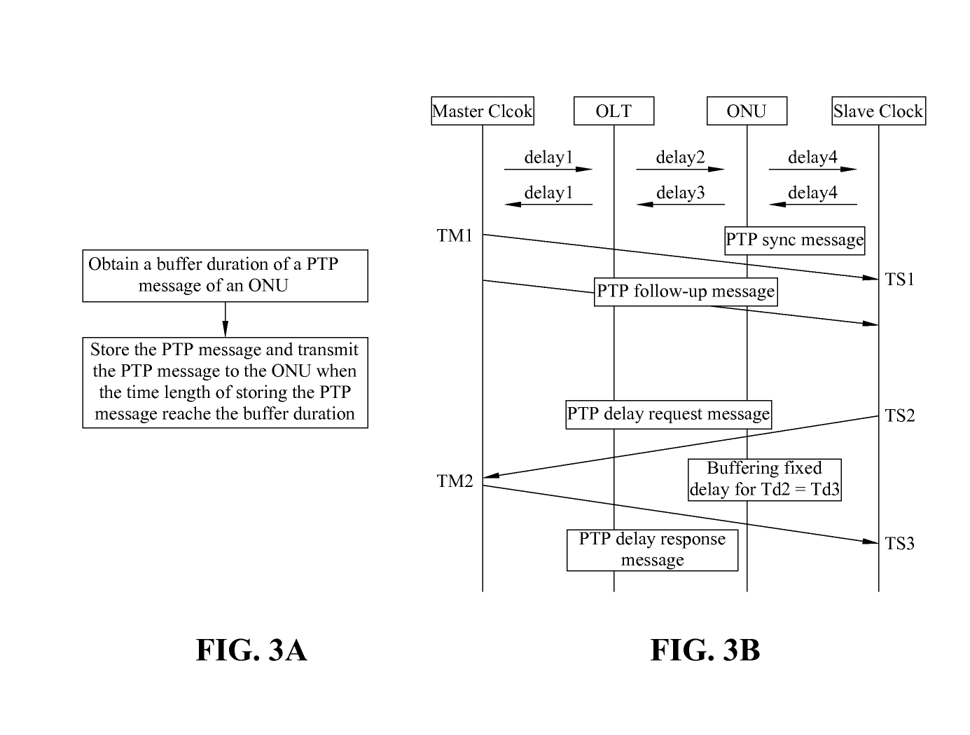

FIG. 4 shows an apparatus for enabling a PON on supporting time synchronization, according to a first exemplary embodiment.

FIG. 5 shows a schematic view for the system timing of the apparatus in FIG. 4, according to an exemplary embodiment.

FIG. 6 shows an apparatus for enabling a PON on supporting time synchronization, according to a second exemplary embodiment

FIG. 7 shows a schematic diagram for the system timing of the apparatus in FIG. 6, according to an exemplary embodiment.

FIG. 8 shows a method for enabling a PON on supporting time synchronization, according to an exemplary embodiment.

FIG. 9 s shows a method for enabling a PON on supporting time synchronization, according to another exemplary embodiment.

### DETAILED DESCRIPTION OF DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

The disclosed exemplary embodiments of the technology for enabling a passive optical network (PON) on supporting time synchronization uses characteristics of performing counting when the ONU locks the OLT clock, such that no PTP synchronization is performed between the OLT and the ONU, and the synchronization information of the OLT informing the ONU may enable the PON on supporting time synchronization capability. In a first exemplary embodiment, this technique may use the characteristics of continuous maintaining synchronization between the ONU and the OLT of the PON to make the PON equivalent to a boundary clock device. In a second exemplary embodiment, this technique may use a timestamp correction module to make a network delay of the PON equivalent to at least one equivalent path delay, wherein the smallest equivalent path delay of the at least one equivalent path delay is zero path delay. Thus the slave clock at the ONU backend may directly synchronize with the master clock. The timestamp correction module may configure a timestamp record module in the OLT of the PON and configure a timestamp update module in the ONU of the PON. The present disclosure does not limit to these two exemplary embodiments.

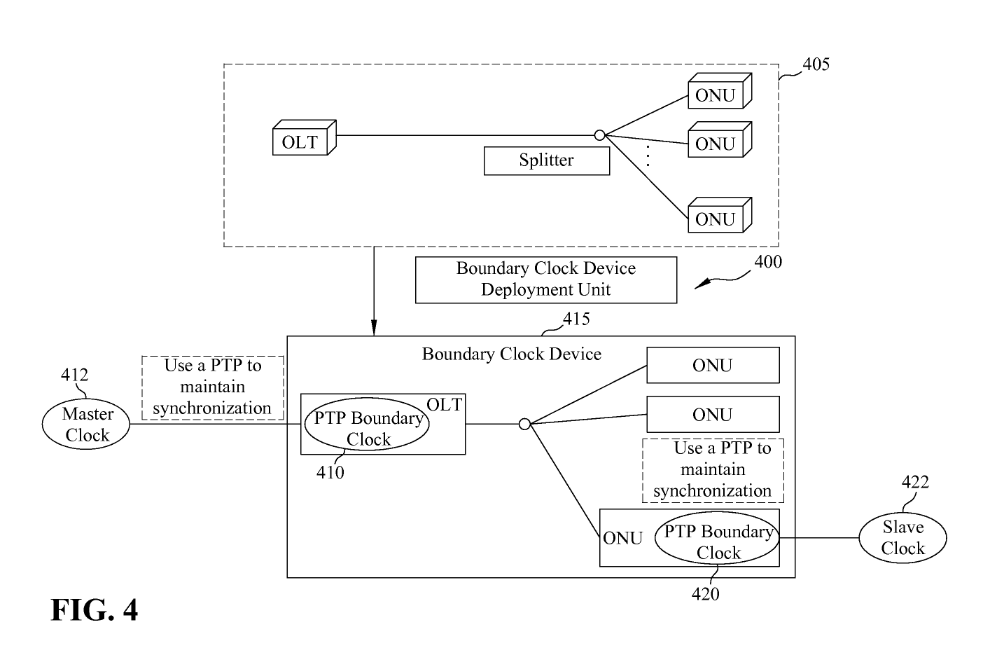

Accordingly, FIG. 4 shows an apparatus for enabling a PON on supporting time synchronization, according to the first exemplary embodiment. Wherein the passive optical network (PON) 405 having an OLT and at least one ONU. As shown in FIG. 4, the apparatus may comprise a boundary clock device deployment unit 400. The boundary clock device deployment unit 400 is configured to make the PON 405 equivalent to a boundary clock device 415, wherein the OLT maintains a precision time protocol (PTP) boundary clock 410, and the ONU maintains a PTP boundary clock 420. In other words, each of the OLT and the ONU maintains a PTP boundary clock. The OLT and a master clock 412 at a frontend of the OLT use a PTP to perform synchronization. A slave clock 422 at a backend of the ONU and the ONU use a PTP to perform synchronization. In other words, the OLT and the master clock 412 at the frontend, and the slave clock 422 at the backend of the at least one ONU and the ONU, use a PTP to maintain synchronization, respectively. Only the synchronization information from the master clock 412 is transmitted between the OLT and the at least one ONU, and the propagation delay between the master clock 412 and the OLT boundary clock 410 is transmitted to the ONU, while performing the PTP synchronization is not needed between the OLT and the ONU. When the at least one ONU receives synchronization information from the OLT, the ONU does not need to perform a precise timestamp annotation. And every time when synchronization is initiated by the master clock, although the OLT maintains a PTP clock, the PTP clock is just used for obtaining the propagation delay with the master clock. The OLT clock does not announce its PTP synchronization information to the ONU of the PON. The ONU may correct the PTP clock of the at least one ONU by using the synchronization information of the OLT and the master clock of the at least one ONU and the propagation delay between the master clock 412 and the OLT boundary clock 410.

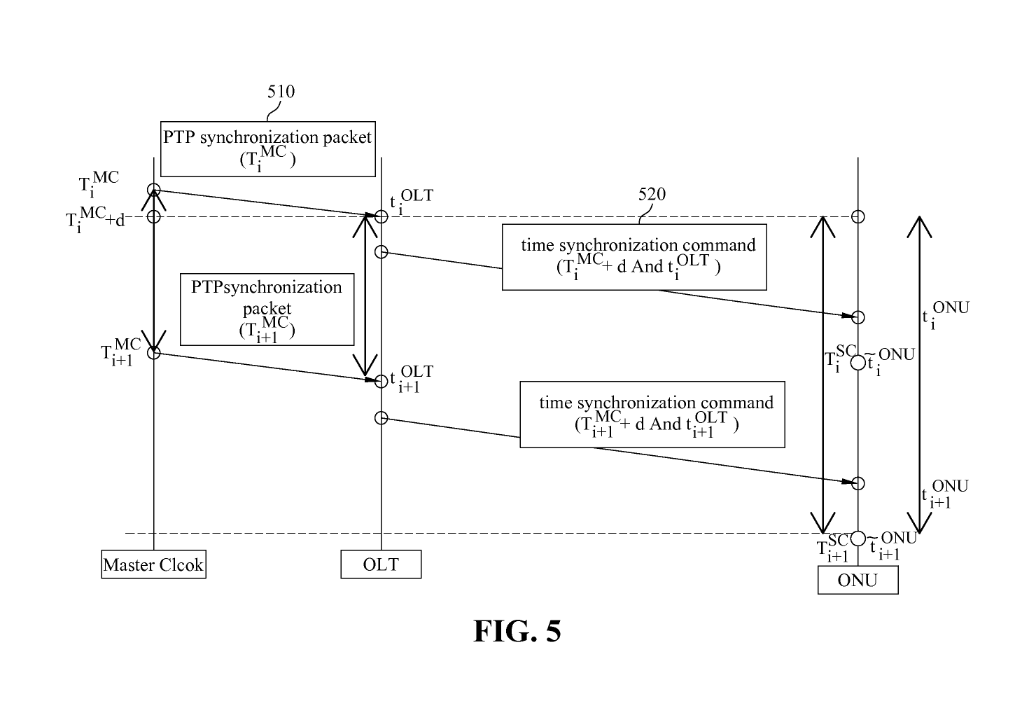

Accordingly, FIG. 5 shows a schematic view for system timing of the apparatus in FIG. 4, according to an exemplary embodiment. In the exemplary embodiment of FIG. 5, the subscript i represents the i-th synchronization related information, i is a positive integer, the symbol MC represents the master clock, the capital T represents the time point of the PTP clock, the lower case t represents respective ToD clock of the OLT and the ONU or the time of the clock maintained by itself. Refer to FIG. 5, at the time point Tᵢ^{MC}, the PTP clock (the master clock 412) at the frontend of the OLT issues a PTP synchronization packet 510; according to a PTP specification, the PTP synchronization packet 510 carries a timestamp of the Tᵢ^{MC}. When the synchronization packet 510 arrives at the OLT, the OLT records time point tᵢ^{OLT} of itself ToD of the OLT. Then the OLT generates a time synchronization command 520 to the ONU. The time synchronization command 520 has the information of Tᵢ^{MC}+d and tᵢ^{OLT} wherein d is the message propagation delay time from the master clock 412 to the OLT. The OLT may obtain the value d from the PTP protocol, or from other methods. When the ONU receives the time synchronization command 520 from the OLT, it takes out the information Tᵢ^{MC}+d and tᵢ^{OLT} from the time synchronization commands 520 to correct the value of the PTP clock (the slave clock 422) at the backend of the ONU, and the ONU does not need to record the time point tᵢ^{ONU} The correction is described in the following.

Each time the ONU receives the time synchronization command from the OLT, it may correct the value T^{SC} of the PTP clock (the boundary clock 420) of the ONU. Take the FIG. 5 as an example to illustrate how to correct the value T^{SC} of the PTP clock (the boundary clock 420) of the ONU. When the ONU receives the (i+1)-th time synchronization command from the OLT, the ONU with the i-th time synchronization command from the OLT has values of four time points, i.e. Tᵢ^{MC}+d, tᵢ^{OLT}, Tᵢ₊₁^{MC}+d, and tᵢ₊₁^{OLT} therefore the ratio of the PTP clock (the master clock 412) at the frontend of the OLT to the ToD count value of the OLT itself may be learned by the two synchronizations (the i-th and the (i+1)th), and is shown as follows:

$$\frac{( {T}_{i + 1}^{MC} - {T}_{i}^{MC} )}{( {t}_{i + 1}^{OLT} - {t}_{i}^{OLT} )} \qquad ( 1 )$$

Since the PTP clock (the master clock 412) at the frontend of the OLT may be different from the ToD count value the OLT itself, so this ratio may not be 1.

Since the ONU locks the time of the OLT, the local ToD of the ONU is basically considered the same as the local ToD of the OLT. Although the ONU receives the i+1th synchronization command at tᵢ₊₁^{ONU}, the method of the present disclosure does not require the ONU to update the PTP clock (the boundary clock 420) immediately. The PTP clock (the boundary clock 420) may be updated at any time after tᵢ₊₁^{ONU}, thus the complexity of the system implementation is reduced. When the ONU updates its PTP clock (the boundary clock 420), assuming that the ToD value of the ONU itself is t̅ᵢ₊₁^{ONU} ( t̅ᵢ₊₁^{ONU} may be any value greater than or equal to tᵢ₊₁^{ONU} as mentioned earlier), since this t̅ᵢ₊₁^{ONU} may be regarded as the ToD value of the OLT itself, thus the count ratio value of the PTP clock (the boundary clock 420) of the ONU to the PTP clock (the master clock 412) at the frontend of the OLT is as follows:

$$\frac{{T}_{i + 1}^{SC} - ( {T}_{i}^{MC} + d )}{( {\tilde{t}}_{i + 1}^{ONU} - {t}_{i}^{OLT} )} \qquad ( 2 )$$

The ratio of formula (2) may be equal to the ratio of the aforementioned formula (1), i.e.

$$\frac{{T}_{i + 1}^{SC} - ( {T}_{i}^{MC} + d )}{( {\tilde{t}}_{i + 1}^{ONU} - {t}_{i}^{OLT} )} = \frac{( {T}_{i + 1}^{MC} - {T}_{i}^{MC} )}{( {t}_{i + 1}^{OLT} - {t}_{i}^{OLT} )} \qquad ( 3 )$$

Therefore, according to the equation (3), the corrected PTP clock (the boundary clock 420) of the ONU is as follows:

$${T}_{i + 1}^{SC} = {T}_{i}^{MC} + d + \frac{( {\tilde{t}}_{i + 1}^{ONU} - {t}_{i}^{OLT} ) \times ( {T}_{i + 1}^{MC} - {T}_{i}^{MC} )}{( {t}_{i + 1}^{OLT} - {t}_{i}^{OLT} )} \qquad ( 4 )$$

Accordingly, the first exemplary embodiment utilizes the characteristics of performing counting for the ONU of the PON by locking the OLT clock, thereby instead of using direct PTP synchronization between the OLT and the ONU, while correcting the PTP clock (boundary clock 420) of the ONU through the time information of the OLT transmitting to the ONU and the local clock or ToD of the ONU. In other words, the synchronization information of the OLT informing the ONU enables the PON having the ability on supporting time synchronization. Wherein, the synchronization information of the OLT transmitting to the ONU includes time points (tᵢ^{OLT}, tᵢ₊₁^{OLT}) of previous time and next time (i.e., the i-th and the (i+1)-th) of the synchronization packet of the master clock 412 arriving at the OLT, the PTP timestamps (Tᵢ^{MC}, Tᵢ₊₁^{MC}) of these two synchronization packets' contents, the message propagation delay time d between the master clock 412 and the OLT, and so on.

In the first exemplary embodiment, the apparatus for enabling a PON on supporting time synchronization capability may further include a processing unit. The processing unit may be configured in the OLT to multi-transmit a plurality of time synchronization messages to the at least one ONU, and in each transmitting a time synchronization message to the at least one ONU, the time synchronization message includes at least a time point of arriving the OLT from a synchronization packet of a master clock, a PTP timestamp of the synchronization packet's contents, and a propagation delay time between the master clock and the OLT. The apparatus for enabling a PON on supporting time synchronization capability may also comprise a PTP clock correction unit. The PTP clock correction unit may be configured in the at least one ONU, and corrects a PTP clock of the at least one ONU based on the aforementioned information included in the time synchronization message from the OLT.

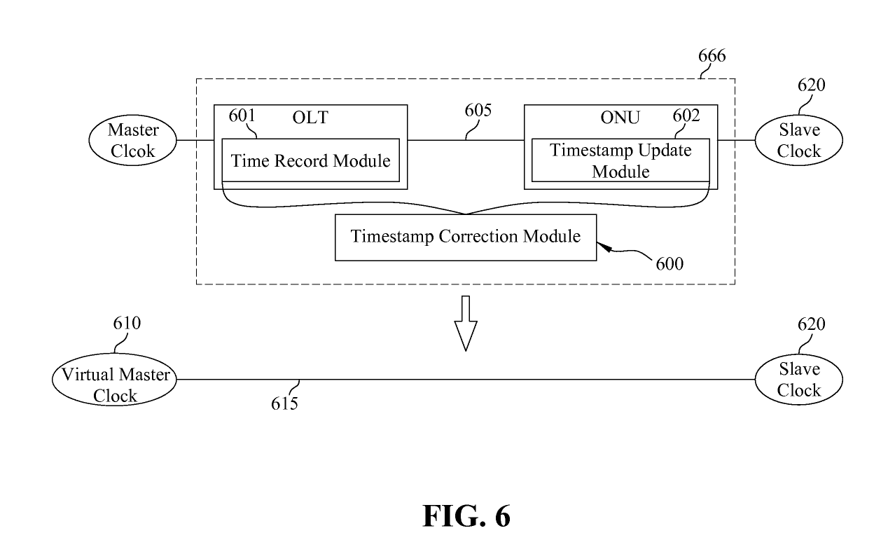

In the second exemplary embodiment, a timestamp correction mechanism is used to make a PON network delay equivalent to a path delay. The OLT and the ONU do not maintain the PTP clock, while the slave clock connected to the ONU's backend directly performs synchronization with the master clock at the frontend of the OLT. The OLT and the ONU use respective ToD clock as the reference of time recording. The OLT and the ONU corporately modify the timestamp information in the PTP packets passing through the PON, to eliminate the propagation delay between the OLT and the ONU. Its effect is equivalent to the slave clock directly performing synchronization with a virtual master clock. Accordingly, FIG. 6 shows an apparatus for enabling a PON on supporting time synchronization, according to a second exemplary embodiment, wherein the passive optical network (PON) has a OLT and at least one ONU.

As shown in FIG. 6, the apparatus may comprise a timestamp correction module 600 located in the PON 666. The timestamp correction module 600 may configure a time record module 601 in the OLT of the PON 666 and configure a timestamp update module 602 in the ONU of the PON 666. The timestamp correction module 600 is configured to make a network delay between a master clock and a slave clock 620 equivalent to at least one equivalent path delay 615. In the at least one equivalent path delay 615, its smallest equivalent path delay is zero path delay. The timestamp correction module 600, through the passive optical network (PON), makes the timestamp update module 602 of the at least one ONU responsible for correcting the timestamp information of at least one PTP synchronization packet from the OLT, and transmits the at least one PTP synchronization packet of corrected timestamp to the slave clock 620 of the at least one ONU's backend. Thus, at least one PTP delay request packet returned by the at least one ONU's backend is performed time stamp correction by the time record module 601 in the OLT. Thereby the slave clock 620 at the ONU's backend is equivalent to perform synchronization with a virtual master clock 610. Accordingly, the OLT and the at least one ONU may not maintain PTP clock, while use itself ToD clock as reference of time recording. Thus, according to the synchronization technology in the exemplary embodiment, the hardware complexity is reduced. The slave clock and the virtual master clock are not directly connected, while the PTP packet of each other is transmitted through a passive optical network (PON). In other words, the OLT and the ONU only maintain their respective local clock or ToD. The slave clock at the ONU's backend and the virtual master clock use the PTP to perform synchronization.

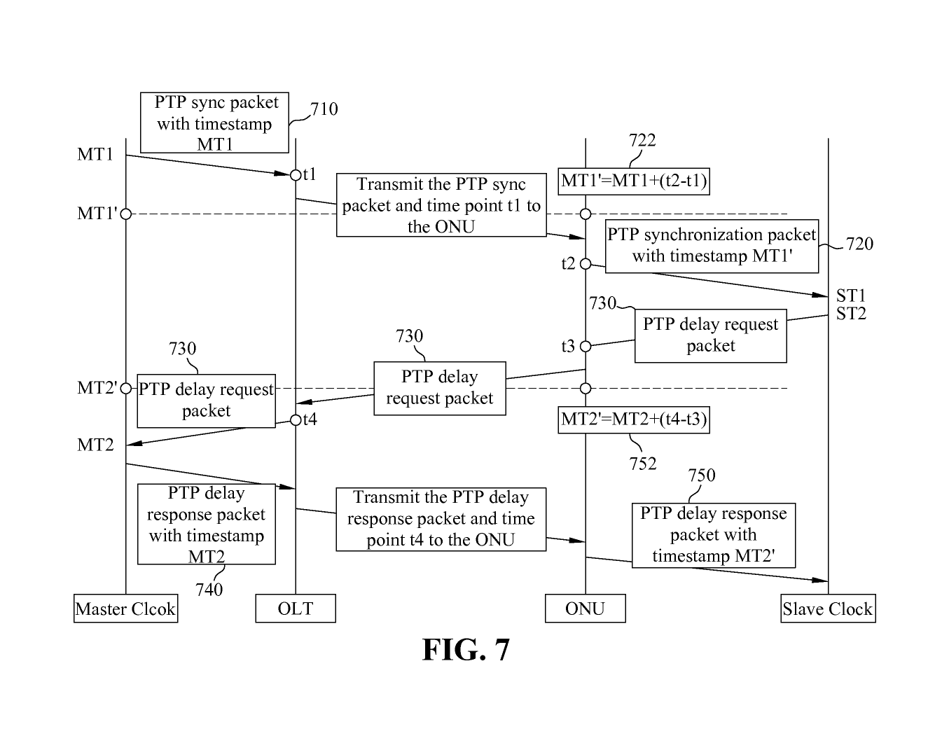

Accordingly, FIG. 7 shows a schematic diagram for the system timing of the apparatus in FIG. 6, according to an exemplary embodiment. In the exemplary embodiment of FIG. 7, when the synchronization starts, the master clock 610 transmits a PTP synchronization packet 710 with the timestamp MT1. When the OLT receives the PTP synchronization packet 710, it records a receiving time point t1, and transmits the PTP synchronization packet 710 and the time point t1 to the ONU. The ONU generates a PTP synchronization packet 720 of a timestamp MT1′ at a time point t2 and transmits to the slave clock 620 at its backend. The slave clock 620 receives the PTP synchronization packet 720 at a time point ST1. The timestamp MT1′ equals to MT1+(t2−t1), as indicated by an arrow 722.

When the ONU receives a PTP delay request packet 730 transmitted from the slave clock 620 at the time point ST2, the ONU records the receiving time point t3 and uplink transmits the PTP delay request packet 730 to the OLT. When the OLT receives the PTP delay request packet 730, the OLT uplink transmits the PTP delay request packet 730 to the master clock 610. The time point that the PTP delay request packet 730 leaving the OLT is t4. Then, the master clock 610 transmits a PTP delay response packet 740 with a timestamp MT2 to the OLT. After the OLT receives the PTP delay response packet 740, the OLT downlink transmits the PTP delay response packet 740 and the time point t4 to the ONU. The ONU is responsible for modifying the timestamp MT2 contained in the PTP delay response packet 740 to a timestamp MT2′. The MT2′ equals to MT2−(t4−t3), as indicated by an arrow 752. After that, the ONU transmits a PTP delay response packet 750 with the timestamp MT2′ to the slave clock 620 at its backend. Thus, the ONU acts as performing synchronization with the virtual master clock 610.

According to the second exemplary embodiment described above in FIG. 6 and FIG. 7, the ONU modifies the timestamp information in the PTP synchronization packet from the OLT, and modifies the timestamp information in a PTP delayed response packet from the OLT, to perform synchronization with virtual master clock 610. Wherein after the ONU receives the PTP synchronization packet 710 with the timestamp MT1, the ONU updates the timestamp information in the PTP synchronization packet 710 according to the timestamp of MT1, the PTP synchronization packet 710 enters into the time point t1 of the OLT, and the time point t2 of the slave clock 620 of the ONU wanting to transmit PTP synchronization packets to the backend. And after the ONU receives the PTP delay response packet 740 with the timestamp MT2, the ONU updates the timestamp information in the PTP delay response packet 740 according to the timestamp MT2, the time point t3 of the PTP delay request packet 730 entering the ONU, and the time point t4 of leaving the OLT.

Although in this example, time stamp modifications are performed in the ONU, the time stamp modifications may be implemented in the OLT using the same concept.

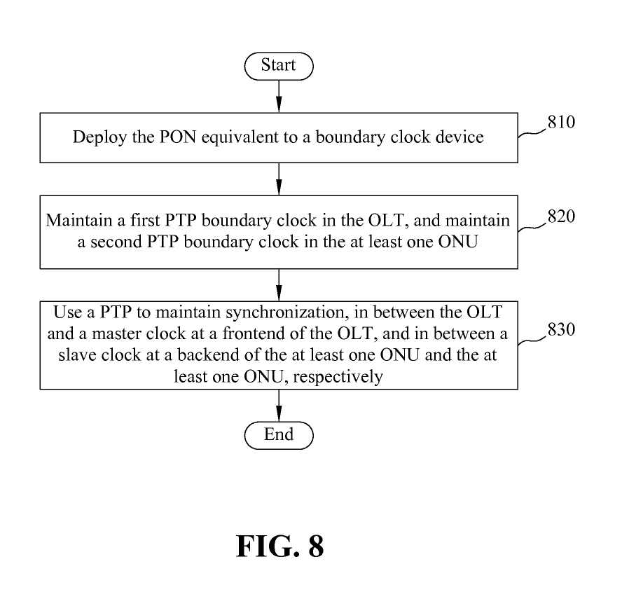

According to the above-described first exemplary embodiment, FIG. 8 shows a method for enabling a PON on supporting time synchronization, according to an exemplary embodiment. Wherein the PON has an OLT and at least one of ONU. Refer to FIG. 8, the method deploys the PON equivalent to a boundary clock device (step 810), and maintains a first precision time protocol (PTP) boundary clock in the OLT, and maintains a second PTP boundary clock in the at least one ONU (step 820), and uses a PTP to maintain synchronization, in between the OLT and a master clock at a frontend of the OLT, and in between a slave clock at a backend of the at least one ONU and the at least one ONU, respectively (step 830).

According to the exemplary embodiment of FIG. 8, in step 830, the method correct the PTP clock of the ONU by using the local clock or ToD of the OLT and the at least one ONU, and the time information of the OLT transmitting to the at least one ONU. The time information such as aforementioned may include a previous and a next time points that a previous and a next synchronization packets of the master clock arrives the OLT, two PTP timestamps in a previous and a next synchronous packets, and a message propagation delay time between the master clock and the OLT. How to correct the PTP clock of the ONU may use such as the aforementioned formula (4), and is not repeatly described here.

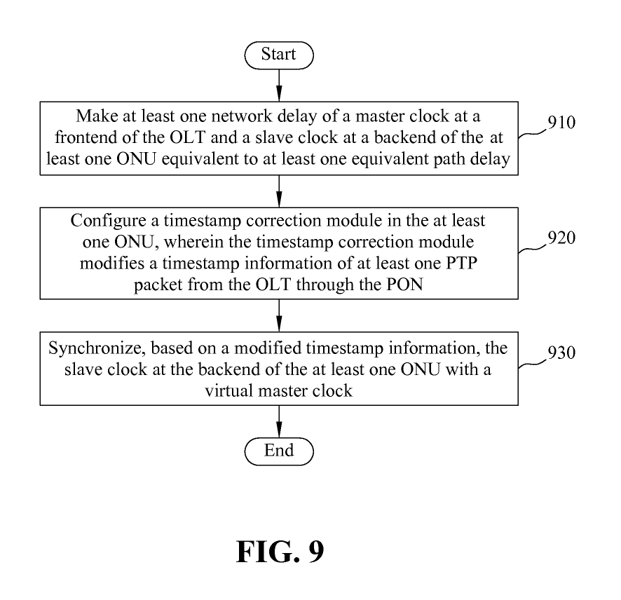

According to the second exemplary embodiment, FIG. 9 shows a method for enabling a PON on supporting time synchronization, according to an exemplary embodiment. The PON has an optical line terminal (OLT) and at least one optical network unit (ONU). Refer to FIG. 9, the method makes at least one network delay between a master clock at a frontend of the OLT and a slave clock at a backend of the at least one ONU equivalent to at least one path delay (step 910), and configures a timestamp correction module in the at least one ONU, wherein the timestamp correction module modifies a timestamp information of at least one PTP packet from the OLT through the PON (step 920), and synchronizes, based on a modified timestamp information, the slave clock at the backend of the at least one ONU with a virtual master clock (step 930).

According to the exemplary embodiment of FIG. 9, in step 910, the OLT and the at least one ONU only maintain their respective local clock or ToD. In step 920, after the timestamp correction module receives a PTP synchronization packet on the at least one ONU, the timestamp correction module generates a new timestamp, based on the timestamp information included in the PTP synchronization packet, a first time point of the PTP synchronization packet entering into the OLT, and a second time point of the at least one ONU transmitting a PTP synchronization packet with the new timestamp to the slave clock. The new timestamp, for example, is the aforementioned MT1′. And, after the at least one ONU receives a PTP delayed response packet, the timestamp correction module updates the timestamp information in the PTP delay response packet, according to the timestamp information in the PTP delay response packet, a third time point of a PTP delay request packet entering the at least one ONU, and a fourth time point of leaving the OLT. The updated timestamp such as is the aforementioned MT2′. In step 930, the slave clock at the ONU's backend and the virtual master clock use a PTP to perform synchronization.

In summary, the exemplary embodiments of present disclosure provide an apparatus and method for enabling PON on supporting time synchronization capability by utilizing the boundary clock PON technology and the virtual master clock technology. The exemplary embodiments resolve the synchronization error of time synchronization mechanism on the PON network. In the first exemplary embodiment, performing PTP synchronization is not necessary between the OLT and the at least one ONU. When the at least one ONU receives the synchronization information from the OLT, also does not need to perform precision stamp annotation. In the second exemplary embodiment, the synchronization technique may reduce the complexity of buffer management, and the hardware complexity is thus reduced. The OLT and the ONU only maintain respective local clock or the time of day clock; and the slave clock at the ONU's backend and a virtual master clock use a PTP to perform synchronization.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An apparatus for enabling a passive optical network (PON) on supporting time synchronization, wherein said PON has an optical line terminal (OLT) and at least one optical network unit (ONU), said apparatus comprising:
a timestamp correction module configured to make at least one network delay between a master clock and a slave clock equivalent to an equivalent path delay;
wherein the timestamp correction module makes the at least one ONU responsible for modifying a timestamp information in at least one precision time protocol (PTP) packet from the OLT through the PON, so that the slave clock at a backend of the at least one ONU is equivalent to synchronizing with a virtual master clock.

2. The apparatus as claimed in claim 1, wherein each of said OLT and said at least one ONU use a respective time of a time of day clock (ToD) as a reference of time recording.

3. The apparatus as claimed in claim 1, wherein said slave clock directly uses a precision time protocol (PTP) synchronizing with said virtual master clock.

4. The apparatus as claimed in claim 1, wherein said slave clock and said virtual master clock are not directly connected, while one or more PTP packets are transmits to each other via said PON.

5. The apparatus as claimed in claim 1, wherein said at least one ONU modifies a timestamp information in a PTP synchronization packet from said OLT and a timestamp information in a PTP delay response packet.

6. The apparatus as claimed in claim 5, wherein said at least one ONU, after receives said PTP synchronization packet, updates said timestamp information according to the timestamp information in said PTP synchronization packet, a first time point of said PTP synchronization packet entering said OLT, and a second time point of said at least one ONU transmitting a PTP synchronization packet with a new timestamp to said slave clock.

7. The apparatus as claimed in claim 5, wherein said at least one ONU, after receives said PTP delay response packet, updates the timestamp information of said PTP delay response packet according to the timestamp information in said PTP delay response packet, a third time point of a PTP delay request packet entering said ONU, and a fourth time point of leaving said OLT.

8. The apparatus as claimed in claim 1, wherein said PTP is a 1588 PTP version of an Institute for Electrical and Electronic Engineers.

9. The apparatus as claimed in claim 1, wherein said timestamp correction module is configured in said PON, and said timestamp correction module further includes:
a time record module, configured in said OLT and responsible for correcting the timestamp information in at least one PTP synchronization packets from said OLT, and transmitting the at least one PTP synchronization packet of being corrected the timestamp information to said slave clock at the backend of the at least one ONU; and
a timestamp update module, configured in said at least one ONU and responsible for correcting a timestamp of at least one PTP delay request packet returned from said at least one ONU.

10. The apparatus as claimed in claim 1, wherein in said at least one equivalent path delay, a smallest equivalent path delay is a zero path delay.

11. A method for enabling a passive optical network (PON) on supporting time synchronization, wherein said PON has an optical line terminal (OLT) and at least one optical network unit (ONU), said method comprising:
making at least one network delay between a master clock and a slave clock equivalent to at least one equivalent path delay;
configuring a timestamp correction module in the PON, wherein the timestamp correction module modifies a timestamp information in at least one PTP packet from a master clock at a frontend of the OLT through the PON; and
synchronizing, based on a modified timestamp information, the slave clock at a backend of the at least one ONU with a virtual master clock.

12. The method as claimed in claim 11, wherein said OLT and said at least one ONU only maintain their respective local clock or time of day clock, and said slave clock uses a PTP to synchronize with said virtual master clock.

13. The method as claimed in claim 11, wherein said timestamp correction module further includes:
generating, after said at least one ONU receiving a PTP synchronization packet, said new timestamp according to the timestamp information in said PTP synchronization packet, a first time point of said PTP synchronization packet entering into said OLT, and a second time point of said at least one ONU transmitting a PTP synchronization packet with a new timestamp to said slave clock.

14. The method as claimed in claim 11, wherein said timestamp correction module further includes:
updating, after said at least one ONU receiving a PTP delay response packet, the timestamp information of said PTP delay response packet according to the timestamp information in said PTP delay response packet, a third time point of a PTP delay request packet entering into said at least one ONU, and a fourth time point of leaving said OLT.

15. The method as claimed in claim 11, wherein said method further includes:
configuring a time record module in said OLT to be responsible for correcting a timestamp information in at least one PTP synchronization packet from said OLT, and transmitting at least one PTP synchronization packet of being corrected the timestamp information to said slave clock at the backend of said at least one ONU; and
configuring a timestamp update module in said at least one ONU to be responsible for a timestamp correction of said at least one PTP delay request packet returned from said at least one ONU.

16. The method as claimed in claim 11, wherein in said at least one equivalent path delay, a smallest equivalent path delay is a zero path delay.
